(19) United States
(12) Patent Application Publication
(10) Pub. No.: US 2026/0163344 A1
(43) Pub. Date: Jun. 11, 2026

(54) WIRE ROUTING UNIT AND WIRE HARNESS

(71) Applicant: YAZAKI CORPORATION, Tokyo (JP)

(72) Inventor: Naoto Kogure, Makinohara-shi (JP)

(21) Appl. No.: 19/412,858

(22) Filed: Dec. 9, 2025

(30) Foreign Application Priority Data
Dec. 11, 2024 (JP) 2024-216921

(51) Int. Cl. H02G 3/04

(52) U.S. Cl. CPC H02G 3/0456

(57) ABSTRACT

A wire routing unit includes: a first fixing part that is fixed to a fixing target; a first holding part that holds a wire against the first fixing part; a second fixing part that is fixed to the fixing target; a second holding part that holds the wire against the second fixing part; and a connecting part that has flexibility and connects the first fixing part and the second fixing part, in which the first fixing part and the second fixing part are integrally molded with the connecting part.

### CROSS-REFERENCE TO RELATED APPLICATION(S)

The present application claims priority to and incorporates by reference the entire contents of Japanese Patent Application No. 2024-216921 filed in Japan on December 11, 2024.

### BACKGROUND OF THE INVENTION

### 1. Field of the Invention

The present invention relates to a wire routing unit and a wire harness.

### 2. Description of the Related Art

As a conventional wire routing unit and wire harness, as described in JP 2024 – 006300 A, for example, there is a known wire routing unit (wiring regulation member) that includes a first holding part and a second holding part for holding wire members, in which the first holding part and the second holding part are connected by a first regulation member and a second regulation member, and the first regulation member and the second regulation member are connected by a connecting member. This wire routing unit can be deformed according to the routing path of the wire members by allowing the connecting member to change the angle formed by the first regulation member and the second regulation member, thereby improving the versatility of a wiring path regulation member.

By the way, there is room for improvement in the above-mentioned wire routing unit and wire harness in that it is sometimes difficult to properly route and secure the wires in accordance with the routing path. For example, when it is desired to route the wires in a curved manner, it is difficult with the wire routing unit described above to route the wires along a curved routing path. For such circumstances, with the wire routing unit described above, it is considered to install many connecting members and route the wires along a curved routing path. However, there is a concern that the number of components may increase.

### SUMMARY OF THE INVENTION

It is therefore an object of the present invention to provide a wire routing unit and a wire harness capable of properly routing wires along a routing path and reducing the number of components.

In order to achieve the above mentioned object, a wire routing unit according to one aspect of the present invention includes a first fixing part that is fixed to a fixing target; a first holding part that holds a wire against the first fixing part; a second fixing part that is fixed to the fixing target; a second holding part that holds the wire against the second fixing part; and a connecting part that has flexibility and connects the first fixing part and the second fixing part, wherein the first fixing part and the second fixing part are integrally molded with the connecting part.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a wire routing unit and a wire harness according to an embodiment;

FIG. 2 is a perspective view of the wire routing unit and the wire harness according to the embodiment;

FIG. 3 is an explanatory diagram of the move of fixing parts in the wire routing unit and the wire harness according to the embodiment;

FIG. 4 is an explanatory diagram of the fixing part in the wire routing unit and the wire harness according to the embodiment; and

FIG. 5 is an explanatory diagram of a wire routing unit according to a comparative example.

### DETAILED DESCRIPTION OF THE PREFERRED EMBODIMENTS

Hereinafter, an embodiment according to the present invention will be described in detail with reference to the accompanying drawings. It is to be noted that the present invention is not limited by the embodiment. Furthermore, the structural components in the following embodiment include those that are easily replaceable by those skilled in the art, or those that are substantially the same.

### Embodiment

The present embodiment relates to a wire routing unit and a wire harness. In the following description, in regards to a first direction, a second direction, and a third direction intersecting with each other, the first direction is referred to as an "extension direction X", the second direction as a "width direction Y", and the third direction as a "height direction Z". Herein, the extension direction X, the width direction Y, and the height direction Z are orthogonal to each other. Note that orthogonal herein includes nearly orthogonal. The extension direction X corresponds, for example, to the direction along which the wire extends. Unless otherwise noted, each of the directions used in the following description indicates the direction in a state where the parts are assembled with each other.

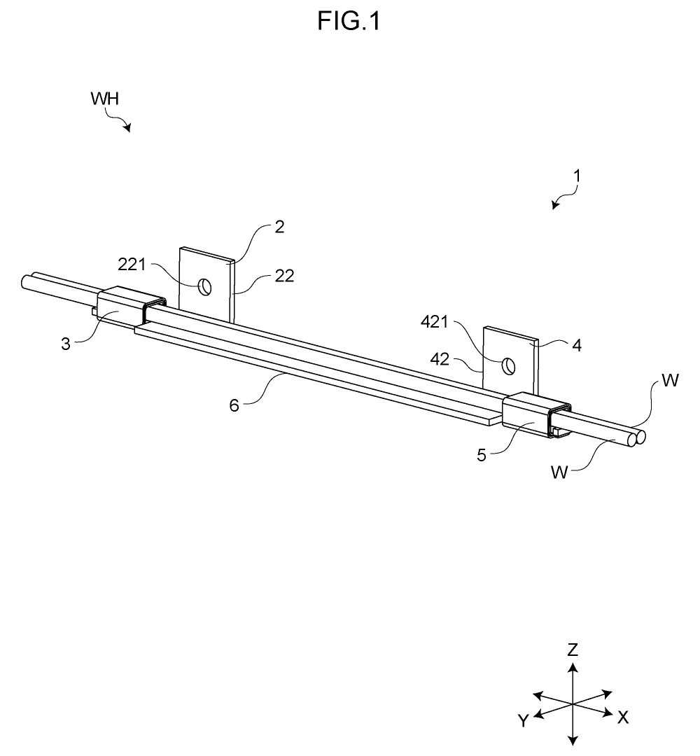

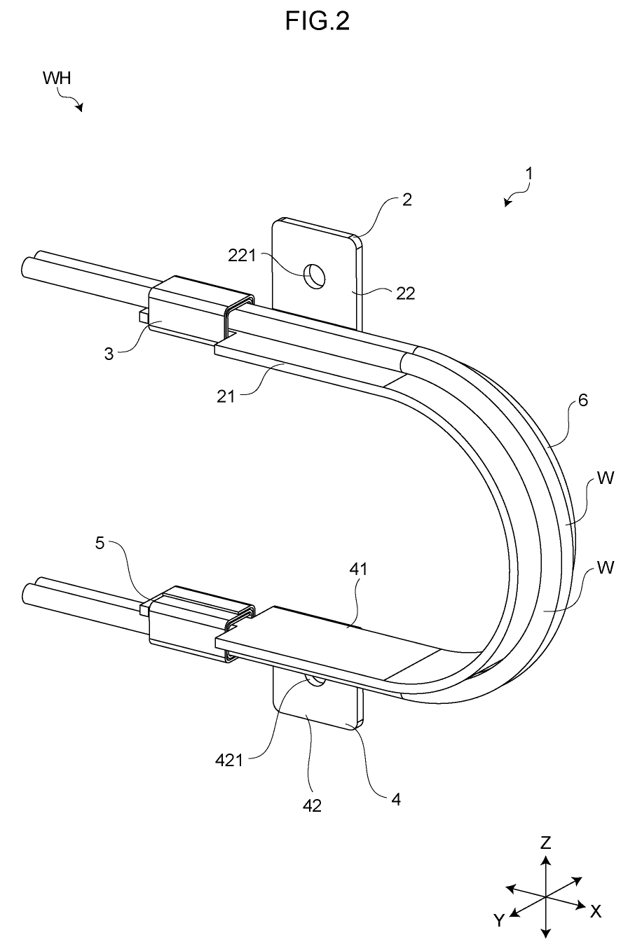

As illustrated in FIG. 1 and FIG. 2, a wire routing unit 1 according to the present embodiment is a unit for routing and fixing wires W to a fixing target, and it is used, for example, by being loaded on a vehicle, more specifically, used for routing transmission movable wires. The wire W is a wiring member or conductive member for enabling electrical connection, and two of those are provided in parallel, for example. Note that number of wires W installed is not limited thereto. The wire routing unit 1 also functions as a wire harness WH including the wires W. FIG. 1 illustrates the wire routing unit 1 and the wire harness WH in a state where the wires W are routed in a straight form, and FIG. 2 illustrates the wire routing unit 1 and the wire harness WH in a state where the wires W are routed along a curved path.

The wire routing unit 1 includes a first fixing part 2, a first holding part 3, a second fixing part 4, a second holding part 5, and a connecting part 6. The first fixing part 2 is a part that fixes the wire routing unit 1 to a fixing target. The fixing target may be, for example, the body of a vehicle, an electrical device, a vehicle component, or the like. The first fixing part 2 includes, for example, a first support piece 21 and a first fixing piece 22. The first support piece 21 and the first fixing piece 22 are each formed in a plate-like shape, and are joined together, for example, in an L-shaped cross section in the direction that intersects with the extension direction X of the wires W. The first support piece 21 is provided along the extension direction X and the width direction Y, and supports the wires W extending in the extension direction X. The first fixing piece 22 is provided along the extension direction X and the height direction Z, and has a fixing hole 221 opened through the front and back. The fixing hole 221 is used as a hole through which a fastening member, not illustrated, is inserted. The first fixing piece 22 is fixed to the fixing target using the fastening member.

The first holding part 3 is a part that holds the wires W, and holds the wires W against the first fixing part 2, for example. The first holding part 3 is provided as a separate member from the first fixing part 2, and can be attached to the first support piece 21. Specifically, the first holding part 3 is formed in a cylindrical shape, provided by covering the outer periphery of the first support piece 21 and the wire W, and holds the wires W against the first support piece 21.

The second fixing part 4 is a part that fixes the wire routing unit 1 to the fixing target, and it is provided by being spaced from the first fixing part 2, and fixes the wire routing unit 1 to the fixing target at a position different from the first fixing part 2. The second fixing part 4 includes, for example, a second support piece 41 and a second fixing piece 42. The second support piece 41 and the second fixing piece 42 are each formed in a plate-like shape, and are joined together, for example, in an L-shaped cross section in the direction that intersects with the extension direction X of the wires W. The second support piece 41 is provided along the extension direction X and the width direction Y, and supports the wires W extending in the extension direction X. The second fixing piece 42 is provided along the extension direction X and the height direction Z, and has a fixing hole 421 opened through the front and back. The fixing hole 421 is used as a hole through which a fastening member, not illustrated, is inserted. The second fixing piece 42 is fixed to the fixing target using the fastening member.

The second holding part 5 is a part that holds the wires W, and holds the wires W against the second fixing part 4, for example. The second holding part 5 is provided as a separate member from the second fixing part 4, and can be attached to the second support piece 41. Specifically, the second holding part 5 is formed in a cylindrical shape, provided by covering the outer periphery of the second support piece 41 and the wires W, and holds the wires W against the second support piece 41.

The connecting part 6 is a part that connects the first fixing part 2 and the second fixing part 4, and exhibits flexibility. The connecting part 6 is formed in a plate-like shape and extends in the direction along which the wires W extend. For example, the connecting part 6 is formed in conjunction with the first support piece 21 of the first fixing part 2 and the second support piece 41 of the second fixing part 4, and provided between the first support piece 21 and the second support piece 41. Therefore, the connecting part 6 can be placed along the wires W that are routed between the first fixing part 2 and the second fixing part 4, and can support the wires W that are routed between the first fixing part 2 and the second fixing part 4.

The connecting part 6 is integrally molded with the first fixing part 2 and the second fixing part 4. In other words, the connecting part 6 is formed with the same material as those of the first fixing part 2 and the second fixing part 4, and it is formed integrally with the first fixing part 2 and the second fixing part 4 by molding. Therefore, the connecting part 6, the first fixing part 2, and the second fixing part 4 are not provided as separate components and can be treated as a single component. This makes it possible to configure the wire routing unit 1 with fewer components, and the number of components can be reduced compared to the case where the connecting part 6, the first fixing part 2, and the second fixing part 4 are each formed as a separate component.

The connecting part 6 is integrally molded with the first fixing part 2 and the second fixing part 4 by resin molding, for example. The connecting part 6 is formed, for example, with a plate thickness capable of changing the extending direction and formed to have flexibility. This allows the connecting part 6 to be provided in a straight form and to be provided in a curved state as well.

Next, a use method of the wire routing unit 1 and the wire harness WH according to the present embodiment will be described.

As illustrated in FIG. 1, the wire routing unit 1 is attached to the wires W, supports the wires W such that the wires W are routed along the routing path, and fixes those to the fixing target.

First, the wire routing unit 1 is installed along the routing path of the wires W. For example, as illustrated in FIG. 1, when the wires W are routed in a straight form, the wire routing unit 1 is installed such that the connecting part 6 is in a straight form. The wires W are held by the first holding part 3 at the position of the first fixing part 2 and held by the second holding part 5 at the position of the second fixing part 4. The first fixing part 2 and the second fixing part 4 are fixed to the fixing target using the fastening members. The wires W are supported by the connecting part 6 between the first fixing part 2 and the second fixing part 4 and routed along the connecting part 6. For example, if the connecting part 6 is not provided in the wire routing unit 1, the wires W are routed between the first fixing part 2 and the second fixing part 4 while hanging down due to their own weight. In this case, there is a concern that the wires W may sway due to vibration. On the contrary, with the wire routing unit 1 and the wire harness WH according to the present embodiment, the wires W can be supported by the connecting part 6 between the first fixing part 2 and the second fixing part 4. Therefore, with the wire routing unit 1 and the wire harness WH according to the present embodiment, it is possible to prevent the wires W from hanging down to be routed between the first fixing part 2 and the second fixing part 4, and to suppress the wires W from swaying due to vibration.

As illustrated in FIG. 2, when the wires W are routed in a curved manner, the wire routing unit 1 is installed by bending the connecting part 6. Since the connecting part 6 has flexibility, it can be bent and installed without difficulty. In this case, for example, the first fixing part 2 and the second fixing part 4 are placed in an inverted state, and fixed to the fixing target. The wires W are held by the first holding part 3 at the position of the first fixing part 2 and held by the second holding part 5 at the position of the second fixing part 4. The wires W are supported by the connecting part 6 between the first fixing part 2 and the second fixing part 4, and routed in a curved state.

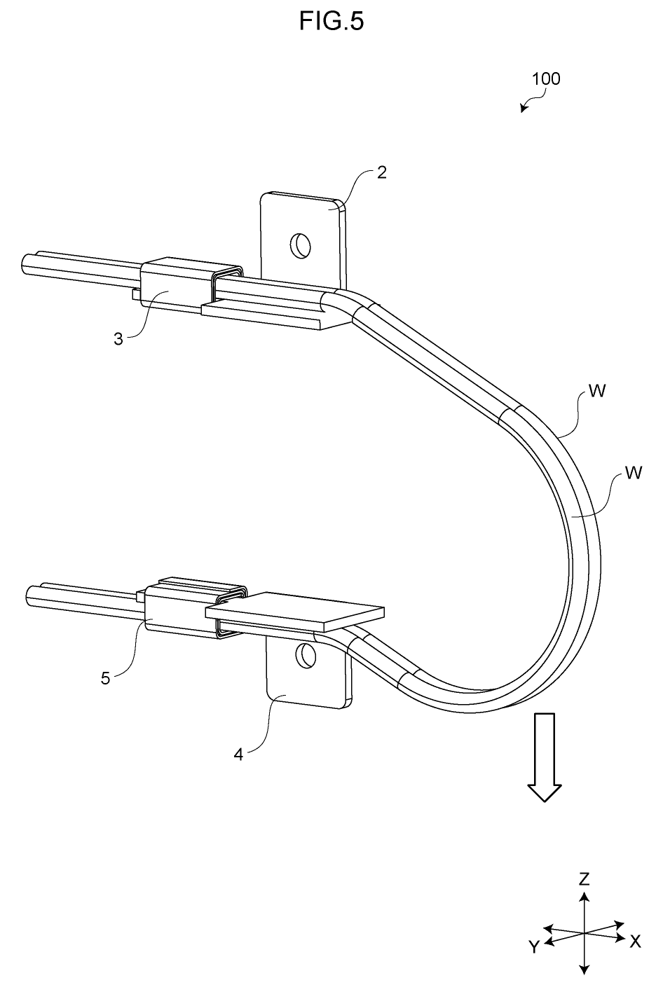

As illustrated in FIG. 5, for example, when the connecting part 6 is not provided between the first fixing part 2 and the second fixing part 4 as in a wire routing unit 100, it is difficult for the wires W to be properly routed. In other words, the wires W are routed between the first fixing part 2 and the second fixing part 4 while hanging down due to their own weight. In particular, when routed in a curved manner, the wires W come to hang down significantly. In this case, there is a concern that the wires W may sway significantly due to vibration. In addition, part of the wires W extending from the first fixing part 2 and the second fixing part 4 is bent and stress is then concentrated thereon. On the contrary, with the wire routing unit 1 according to the present embodiment, the wires W can be supported by bending the connecting part 6 between the first fixing part 2 and the second fixing part 4. Therefore, with the wire routing unit 1 and the wire harness WH according to the present embodiment, it is possible to prevent the wires W from hanging down to be routed between the first fixing part 2 and the second fixing part 4, and to suppress the stress from concentrating on the wires W, thereby making it possible to bend and properly route the wires W.

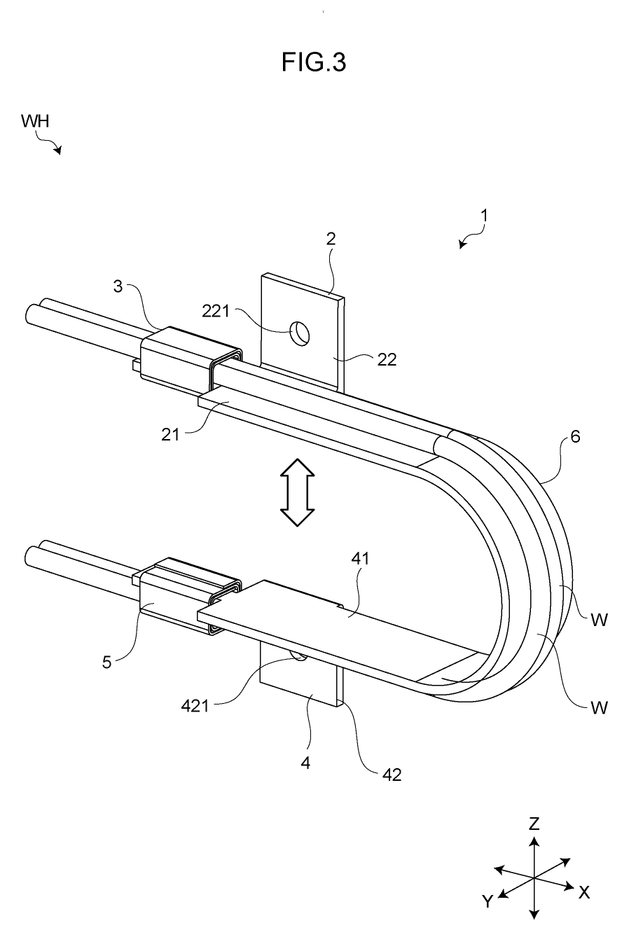

As illustrated in FIG. 3, the wire routing unit 1 may also be used in a mode in which one of the first fixing part 2 and the second fixing part 4 is moved. In other words, in a state where the connecting part 6 is installed to be bent and the wires W are routed along the connecting part 6 in a curved manner, the wire routing unit 1 may be used in a mode in which the first fixing part 2 and the second fixing part 4 are moved to be distant or to be close to each other. In this case, the curvature of the connecting part 6 and the wires W come to change due to the move of the first fixing part 2 or the second fixing part 4. Since the connecting part 6 exhibits flexibility, it can be elastically deformed and bent by changing the curvature in accordance with the move of the first fixing part 2 or the second fixing part 4 to properly support the wires W. Therefore, with the wire routing unit 1 and the wire harness WH according to the present embodiment, it is possible to suppress the stress from concentrating on the wires W and to bend and properly route the wires W even when used in a mode in which the first fixing part 2 or the second fixing part 4 is moved.

The wire routing unit 1 and the wire harness WH enable smooth fixing work to the fixing target through connecting the first fixing part 2 and the second fixing part 4 by the connecting part 6. For example, in the wire routing unit 1, when the first fixing part 2 is fixed to the fixing target, the direction and position regarding the fixing position of the second fixing part 4 is limited by the connecting part 6, which prevents the wires W from being twisted to be routed, and makes it easy to do the fixing work of the second fixing part 4. Therefore, the wire routing unit 1 and the wire harness WH enable smooth fixing work to the fixing target compared to a case where the connecting part 6 is not provided.

As described above, with the wire routing unit 1 and the wire harness WH according to the present embodiment, the wires W can be properly routed along the routing path between the first fixing part 2 and the second fixing part 4 through connecting the first fixing part 2 and the second fixing part 4 by the connecting part 6. Furthermore, with the wire routing unit 1 and the wire harness WH according to the present embodiment, the wires W can be properly routed in a curved manner even when the routing path is curved because the connecting part 6 has flexibility.

Furthermore, with the wire routing unit 1 and the wire harness WH according to the present embodiment, the number of components can be reduced by integrally molding the first fixing part 2 and the second fixing part 4 with the connecting part 6. In addition, the wire routing unit 1 and the wire harness WH enable smooth fixing work to the fixing target by integrally molding the first fixing part 2 and the second fixing part 4 with the connecting part 6.

Note that the wire routing unit and the wire harness according to the present invention are not limited by the embodiment described above, and various changes are possible within the scope of the appended claims. The wire routing unit 1 and the wire harness WH according to the present embodiment may also be configured by combining the structural components of the embodiment described above as appropriate.

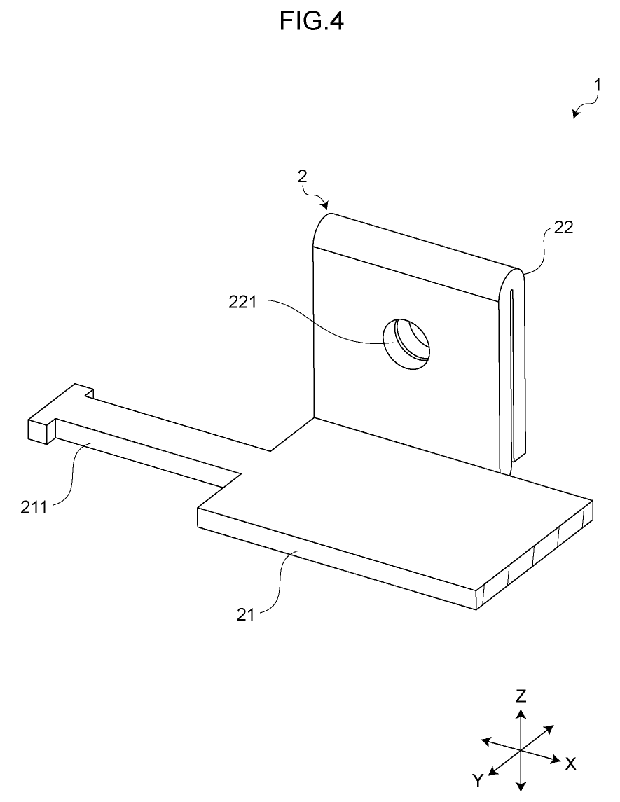

For example, in the wire routing unit 1 and the wire harness WH according to the present embodiment described above, the first fixing part 2 includes the first fixing piece 22 and the second fixing part 4 includes the second fixing piece 42. The rigidity of the first fixing piece 22 and the second fixing piece 42 may be configured to be higher than that of the connecting part 6. For example, as illustrated in FIG. 4, the first fixing piece 22 may be configured to be thick by double-folding a plate material. In this case, the thickness of the first fixing piece 22 can be increased to enhance the strength of the first fixing piece 22, and fixing of the wire routing unit 1 to the fixing target can be stabilized. In FIG. 4, a narrow part 211 is a part for attaching the first holding part 3. The second fixing piece 42 may also be configured in the same manner as the first fixing piece 22 illustrated in FIG. 4. By configuring the wire routing unit 1 and the wire harness WH in this manner, the strength of the first fixing part 2 and the second fixing part 4 can be increased without decreasing the flexibility of the connecting part 6.

Furthermore, as for the wire routing unit 1 and the wire harness WH according to the present embodiment described above, the case in which the first fixing part 2 and the second fixing part 4 are integrally formed with the connecting part 6 by resin molding is described. However, the first fixing part 2 and the second fixing part 4 may be integrally formed with the connecting part 6 by methods other than resin molding. For example, the first fixing part 2 and the second fixing part 4 may be integrally formed with the connecting part 6 by press molding or stamping. In this case as well, as with the wire routing unit 1 and the wire harness WH according to the present embodiment described above, the wires W can be properly routed along the routing path between the first fixing part 2 and the second fixing part 4, and fixing work to the fixing target can be performed smoothly by integrally molding the first fixing part 2 and the second fixing part 4 with the connecting part 6.

According to the wire routing unit and the wire harness according to the present embodiment, wires can be properly routed along the routing path and the number of components can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire routing unit comprising:
a first fixing part that is fixed to a fixing target;
a first holding part that holds a wire against the first fixing part;
a second fixing part that is fixed to the fixing target;
a second holding part that holds the wire against the second fixing part; and
a connecting part that has flexibility and connects the first fixing part and the second fixing part, wherein
the first fixing part and the second fixing part are integrally molded with the connecting part.

2. A wire harness comprising:
a wire; and
a wire routing unit assembled to the wire, wherein
the wire routing unit comprises:
a first fixing part that is fixed to a fixing target;
a first holding part that holds the wire against the first fixing part;
a second fixing part that is fixed to the fixing target;
a second holding part that holds the wire against the second fixing part; and
a connecting part that has flexibility and connects the first fixing part and the second fixing part, and
the first fixing part and the second fixing part are integrally molded with the connecting part.
